(19) United States
(12) Patent Application Publication
(10) Pub. No.: US 2013/0030829 A1
(43) Pub. Date: Jan. 31, 2013

(54) METHOD AND DEVICE FOR PROCESSING STATE DATA OF A PATIENT

(71) Applicant: Igor TCHOUDOVSKI, Waiblingen (DE)

(72) Inventor: Igor TCHOUDOVSKI, Waiblingen (DE)

(21) Appl. No.: 13/557,041

(22) Filed: Jul. 24, 2012

(30) Foreign Application Priority Data
Jul. 29, 2011 (DE) 10 2011 080 145.6

(51) Int. Cl. G06Q 50/22

(52) U.S. Cl. 705/2

(57) ABSTRACT

A method for processing state data of a patient includes: acquisition of a time of a reception of an acoustic or optical signal of the patient, the acoustic or optical signal representing a signal with which the patient can express his state; a transmission step in which a data file that represents the acoustic or optical signal and that is provided with an item of information about the time is transmitted to a management device via a transmit interface of an input device; a receive step in which the data file is received via a receive interface of the management device; and a step of storing the data file, in the form of a text data file or image data file, in a register which is assigned to the patient and which includes a multiplicity of text data files or image data files.

### BACKGROUND OF THE INVENTION

1. Field of the Invention

The present invention relates to a device and a method for acquiring, processing and storing state data of a patient.

2. Description of the Related Art

During anamnesis, the physician queries patients about their discomfort. The patients often do not fully recall the discomfort, or the date or time of its occurrence. For some illnesses, patients keep a diary. This is laborious, and patients often forget to make entries.

Published German patent application document DE 602 11 197 T2 presents the conversion of dictation data files to text data files and their automatic revision, so that the text is provided to the author as quickly and as free of errors as possible.

### BRIEF SUMMARY OF THE INVENTION

Against this background, the present invention presents a device and a method for acquiring, processing and storing state data of a patient, and a corresponding computer program product.

If the patient is given the possibility of recording his sensations at any time and with little effort, the patient will make use of this possibility. In this way, the state of the patient can be documented without gaps. If a treating physician is additionally given the possibility of conveniently accessing the data recorded by the patient, the physician will also make use of the recorded data. The recorded data make it easier for the physician to produce a diagnosis for the patient. In addition, the recorded data provide confirmation of a diagnosis already produced for the patient.

The present invention is concerned with the provision of a simple possibility for documenting the subjective sensations, i.e. state of health or pains, of patients, and to make them available to the treating physician. These data can support the physician during the creation or confirmation of a diagnosis, in particular if the data are provided in processed form.

In order to make it easier for the patient to record his sensations, a speech input method can be provided. The speech input makes it possible for the patient to record his sensations as soon as they are known to him. In this way, it can be avoided that the patient will forget to make a later recording, for example in a book. A verbal articulation of his sensations can also help the patient to come to terms with them, instead of repressing them. Thus, through verbal articulation of his sensations the patient may already be inspired to take suitable measures to seek improvement.

In order to make the recorded data available to the treating physician, the data, recorded by the patient using an input device, can be transmitted to a management device to which the physician has access. In order to make it easier for the physician to view or analyze the recorded data, the recorded data can be processed in a suitable manner and stored in processed form.

In this way, a patient diary can be realized that is operable by voice and that has a connection to a telemedical system.

The present invention creates a method for processing state data of a patient, having the following steps:
Acquisition of a time of reception of an acoustic or optical signal of the patient, the acoustic or optical signal representing a signal with which the patient can express his state;
Transmission of a data file representing the acoustic or optical signal, and provided with an item of information about the time, to a management device via a transmit interface of an input device;
Reception of the data file via a receive interface of the management device; and
Storage of the data file in the form of a text data file or image data file in a register assigned to the patient and including a multiplicity of text data files or image data files.

The patient can be a living being capable of communicating its state through speech or acoustic sounds. The patient may also be an object, such as a building or a mountainside, in which a change of state, such as a shift, causes characteristic sounds. In the following, as an example it is assumed that the patient is a human being capable of communicating its state via the acoustic signal. The acoustic signal can for example include spoken words, sounds, or noises of the patient. The state can represent sensory impressions perceived by the patient and regarded by the patient as relevant for the creation of a diagnosis. For example, the state may relate to pain, freedom from pain, dizziness, feelings of numbness, hunger, thirst, feelings of happiness, fear, depression, or also a state for example of the skin or of other organs. Information influencing the state, such as the taking of a medication, a beverage, or a meal, can also be communicated in the form of the acoustic signal, and can be recorded in a manner corresponding to or in addition to a state, and stored as a text file. The acoustic signal can be received by an input device, for example via a microphone. The input device can be a wearable device operated by the patient in order to record his states. If via the input device an acoustic signal is received that is rated as a relevant signal, i.e. a signal of which it is assumed that it contains state data of the patient, the acoustic signal can be stored as a data file. The acoustic signal or data file can here be provided with a timestamp that defines the time of reception of the acoustic signal via the input device. The time can include both a current date and a current clock time. The data file can include the acoustic signal in the form of compressed or uncompressed audio data. Alternatively, the data file can include an evaluated form of the acoustic signal. For example, the acoustic signal can be subjected to speech recognition or noise classification, and the data file can include a result of the evaluation in the form of text information. The transmit interface can be a wireless or wired transmission interface via which the data file can be transmitted from the input device to a management device. The data file can be transmitted while the acoustic signal is received, as soon as the acoustic signal has been completely received, or at a later time. The later time can be determined by the patient, by the input device, or by the management device. If the data file is transmitted at a later time, the data file, and, if warranted, further data files produced on the basis of further acoustic signals, can be intermediately stored up to the time of the transmission. If the data file is transmitted immediately, it can be transmitted in segments, such that each segment of the data file can include a segment of the acoustic signal. The management device can be situated so as to be spatially separated from the input device. In this way, the input device and the management device can be two separate devices that can operate self-sufficiently, and may be connected to each other only via a transmit interface. For example, the input device and the management device may be situated so as to be several meters or several kilometers distant from one another. Before, during, or after the transmission of the data file, the data file can be provided with a patient identifier. In this way, the information contained in the data file can be assigned to the patient. If the information of the acoustic signal was already converted into a text data file by the input device, the text data file received by the management device can be stored directly in the register. The register is intended to represent a suitable storage structure in which text data files can be stored. The register can in this way act as a patient file. If in contrast the received data file contains an audio signal, the management device can be fashioned to generate the text data file from the audio signal and to subsequently store the text data file in the register. The management device can also be fashioned so as to first store the data file including the audio signal in the register and to convert it to the text data file at a later time. The input device can continuously receive audio signals of the patient and transmit them as a data file to the management device. The register can be continuously supplemented with received data files. The management device can be fashioned to receive data files from different input devices of different patients. In this way, the management device can have a multiplicity of registers, each register being assigned to one of the patients and including only data files assigned to this patient.

According to a specific embodiment, in the acquisition step an image can be acquired, for example of a body part or of a wound of the patient. A plurality of images may also be acquired in the form of a film, by which the patient can for example record a movement sequence. In the transmission step, a data file additionally including the image or images can be transmitted to the management device via the transmit interface. In the storage step, the image or images are stored in the register assigned to the patient. In this way, a data set of the patient can for example be supplemented with an image of a wound. The reception of an acoustic or optical signal can here be interpreted such that either only an acoustic signal, only an optical signal, or both an optical or acoustic signal is received. The same holds correspondingly for the further OR-linkages in this context, which may also be understood as AND/OR-linkages. The acoustic signal can be received simultaneously with or temporarily offset from the optical signal.

The method can include a step of receiving a selection criterion via an input interface of the management device. In a search step, a search can take place for a text data file or image data file corresponding to the selection criterion. In an output step, the text data file or image data file corresponding to the selection criterion can be outputted via an output interface of the management device. The selection criterion can be inputted by a user of the management device, for example the physician, via the input interface. The selection criterion can for example be a word, and in the search step all text data files of the patient that contain the word are sought. The selection criterion may also be a span of time, and in the search step all text data files can be sought that are based on acoustic signals acquired during the span of time. The output interface can be connected to a display device such as a display screen or a printer.

The method can include a step of conversion of the data file representing the acoustic signal into the text data file. The conversion step can be carried out in the input device or in the management device. The conversion can be carried out using known algorithms, for example speech recognition algorithms. The conversion converts the state information contained in the acoustic signal into a format that is easy to process further and easy to evaluate. The memory space requirement of a text data file is also less than that of an audio data file. If the conversion takes place in the input device, the quantity of data to be transmitted to the management device via the interface can be reduced. In addition, the method can include a step of conversion of the data file representing the optical signal into the image data file. Here, suitable image processing methods can be used.

In an analysis step, the information contained in the text data file can be analyzed. In particular, the text data file can be analyzed with regard to its information content describing the state of the patient. The analysis can be carried out for example on the basis of keywords. If the information content of a text data file is rated as not relevant, the text data file can be deleted or not further processed. In this way, the filling of the register with unimportant information can be prevented.

The method can include a step of recognizing an actuation of an actuating device of the input device that can be actuated by the patient. In a receive step, the acoustic or optical signal can be received and can be stored as the data file representing the acoustic or optical signal. This can take place as a response to the recognition of the actuation. The actuating device can for example be a switch or pushbutton. The actuation can start the recording of the acoustic signal by the input device. The actuation can also already activate the transmit interface of the input device in order to enable a direct or prompt transmission.

In the transmission step, the data file can be transmitted wirelessly. This makes it easy for the patient to carry the input device with him. The transmission can take place via a telephone connection, an Internet connection, or some other suitable type of connection. For example, in this way state data of the patient can be transmitted even when the patient is situated far from the management device, for example due to being on vacation.

According to a specific embodiment, the method can include a step of acquisition of a further time of a reception of a further acoustic or optical signal of a further patient. Here, the further acoustic or optical signal can represent a signal with which the further patient can express his state. In a transmission step, a data file representing the further acoustic or optical signal, and provided with an item of information concerning the further time, can be transmitted to the management device via a transmit interface of a further input device. In a receive step, the further data file can be received via the receive interface of the management device. In a storage step, the further data file can be stored in the form of a text data file or image data file, in a further register assigned to the further patient and including a multiplicity of text data files or image data files. Using a management device, in this way state data of a multiplicity of patients can be managed. For the analysis of the stored text data files or image data files, via the input interface a selection criterion can be inputted that is assigned to one patient, a group of patients, or all patients. In this way, it is possible to examine not only the register of just one patient, but rather the registers of a plurality of patients or of all patients, with regard to the selection criterion. This facilitates finding connections between the courses of illness of individual patients, for example in the case of epidemics.

In addition, the present invention creates a method for acquiring state data of a patient using an input device, having the following steps:
acquisition of a time of a reception of an acoustic or optical signal of the patient by the input device, the acoustic or optical signal representing a signal with which the patient can express his state; and
providing a transmit interface of the input device with a data file that represents the acoustic or optical signal and that is provided with an item of information about the time.

The method can be realized in an input device that can be used by the patient to record his state. Here, the patient can use the input device to record a state whenever he becomes conscious of the occurrence of a state that he regards as relevant. The input device can also be fashioned to prompt the patient to record a state, for example in a time-controlled manner. The input device can be a wearable device having its own power supply, for example in the form of an accumulator.

In addition, the present invention creates a method for storing state data of the patient using a management device, having the following steps:
receiving a data file via a receive interface of the management device, the data file representing an acoustic or optical signal of the patient acquired by an input device, and being provided with an item of information concerning a time of the acquisition of the acoustic or optical signal by the input device; and
storing the data file in the form of a text data file or image data file in a register assigned to the patient and including a multiplicity of text data files or image data files.

The method can be realized in a management device by which the state data recorded by one patient or by a plurality of patients can be stored. The stored state data can be made available by the management device for further evaluation. The management device can include a stationary computer, for example a database server.

The present invention also provides a device that is fashioned to carry out or realize the steps of at least one method according to the present invention in corresponding devices. The object on which the present invention is based is also solved quickly and efficiently by this variant embodiment of the present invention in the form of a device. For example, an input device can be fashioned to realize the steps of the method for acquiring state data of a patient. A management device can be fashioned to realize the steps of the method for storing state data of a patient. A system for processing state data of at least one patient can include at least one input device and a management device that are coupled to one another in order to jointly carry out the method step of processing state data of one or more patients.

In the present context, a device is to be understood as an electrical apparatus that processes sensor signals and outputs control signals as a function thereof. The device can have an interface that can be fashioned in terms of hardware and/or software. In the case of a hardware realization, the interfaces can for example be part of a so-called system ASIC that contains a wide variety of functions of the device. However, it is also possible for the interfaces to be separate integrated circuits, or to be made up at least partly of discrete components. In the case of a software realization, the interfaces can be software modules that are for example present on a microcontroller alongside other software modules.

Also advantageous is a computer program product having program code that can be stored on a machine-readable carrier such as a semiconductor memory device, a hard drive memory device, or an optical memory device, and is used to carry out the method according to one of the above-described specific embodiments if the program is executed on a computer or device. If a mobile telephone, for example a smartphone, is used to realize the method for processing state data of a patient, the method, or partial steps of the method, can be realized in the form of an application program, for example a so-called app. The application program can be loaded onto the mobile telephone by the user via an interface in order to equip the mobile telephone with the functionality according to the present invention.

### BRIEF DESCRIPTION OF THE DRAWINGS

FIG. 1 shows a block diagram of a system for processing state data of a patient according to an exemplary embodiment of the present invention.

FIG. 2 shows a block diagram of an input device according to an exemplary embodiment of the present invention.

FIG. 3 shows a block diagram of a management device according to an exemplary embodiment of the present invention.

FIG. 4 shows a system for processing state data of a patient according to an exemplary embodiment of the present invention.

FIG. 5 shows a flow diagram of a method for processing state data of a patient according to an exemplary embodiment of the present invention.

### DETAILED DESCRIPTION OF THE INVENTION

In the following description of preferred exemplary embodiments of the present invention, identical or similar reference characters are used for the elements shown in the various Figures and having similar functions, and a repeated description of these elements is omitted.

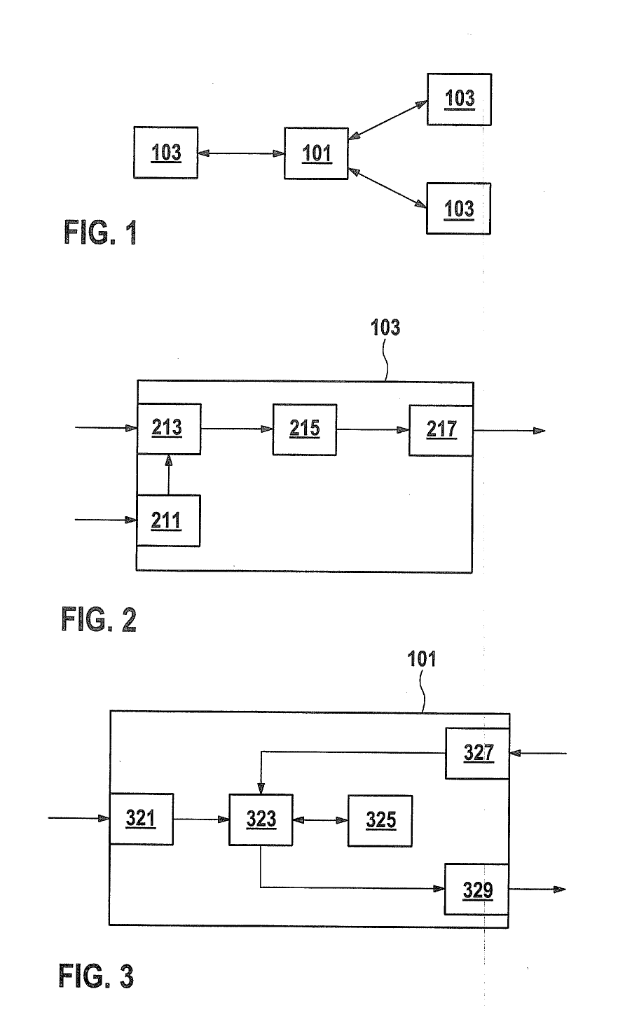

FIG. 1 shows a block diagram of a system for processing state data of a patient according to an exemplary embodiment of the present invention. According to this exemplary embodiment, the system has a central management device 101 and a multiplicity of input devices 103. Shown are three input devices 103. Alternatively, the system can also include only management device 101 and a single input device 103. Each of the input devices 103 is connected to management device 101 via an interface. The interfaces can be realized as bidirectional interfaces. Alternatively, the interfaces can be realized so as to be unidirectional from input device 103 to management device 101.

Each of the input devices 103 is assigned to a patient. The patients can use their assigned input device 103 to record their states, sensations, or other relevant events or actions. The recording can take place in each case of via speech acquisition by input devices 103. The data recorded by input devices 103 can be transmitted to management device 101 via the respective interface. The transmitted data can be prepared and stored by management device 101. In order to be able to assign the transmitted data to the patients, the data can be provided with an identifier for the respective patient or the respective input device 103. A physician of the patient can for example access the data stored by management device 101. The physician is named here as representative of a caregiver, medical specialist, nurse, care manager, etc. The physician can use the stored data of a patient to create a diagnosis for the patient, to confirm a diagnosis that has been made, or as a signal to ask the patient to come for an examination.

FIG. 2 shows a block diagram of an input device 103 according to an exemplary embodiment of the present invention. Input device 103 can be used in connection with the system shown in FIG. 1. Input device 103 is fashioned to record, in response to an actuation by a patient, an acoustic signal, for example speech, of the patient, and to output a data file generated from the acoustic signal or a data stream based on the acoustic signal. For this purpose, according to this exemplary embodiment input device 103 has an actuating device 211, a recording device 213, a converter 215, and a transmit interface 217. In addition, input device 103 can have a storage device that makes it possible to first collect the acquired data and to intermediately store this data. Input device 103 can be of a size such that the patient is able to hold input device 103 in the hand. For example, input device 103 can have a size of a few millimeters or centimeters in its height, width, and length.

Actuating device 211 is fashioned in order to detect an actuation by the patient. For example, actuating device 211 can be realized as a switch, a contact sensor, or a proximity sensor. Actuating device 211 can be fashioned so as to be actuated for example by a fingertip of a finger of the patient. Alternatively, actuating device 211 can be actuated by a speech command, or in some other suitable manner. Actuating device 211 is fashioned so as to activate recording device 213 in response to an actuation that has taken place. For this purpose, actuating device 211 can be fashioned so as to output an activation signal to recording device 213. After activation has taken place, recording device 213 is fashioned so as to record an acoustic signal of the patient. For example, recording device 213 can be realized as a microphone. Recording device 213 is fashioned to output to converter 215 an analog or digital audio signal corresponding to the acoustic signal, as a data file or as a continuous data stream. According to this exemplary embodiment, converter 215 is fashioned so as to convert the audio data received from recording device 213 into text data. For this purpose, converter 215 can be fashioned so as to carry out speech recognition. Converter 215 is fashioned so as to output the produced text data to transmit interface 217. Alternatively, converter 215 can be omitted or replaced by a buffer storage device, and the audio signal of recording device 213 can be outputted to transmit interface 217 without being converted to text. The audio signal produced by recording device 213, or the text data produced by converter 215 based on the audio signal, are provided with a timestamp by appending additional data, said timestamp defining a time of the recording of the acoustic signal by recording device 213. The provision of the data with the timestamp can be carried out by recording device 213, by converter 214, by actuating device 211, by transmit interface 217, or by some other suitable device. Transmit interface 217 is fashioned so as to send out the data received by converter 215 or received directly by recording device 213. According to this exemplary embodiment, transmit interface 217 is fashioned so as to send out the transmitted data together with an identifier assigned to input device 103. According to this exemplary embodiment, transmit interface 217 is fashioned so as to enable a wireless transmission. For this purpose, transmit interface 217 has a suitable antenna.

According to an exemplary embodiment, input device 103 has a camera with which the patient can take a photograph of himself. The image recorded by the camera can be outputted to transmit interface 217 in order to be sent out by transmit interface 217 together with the text data, or separately from the text data. Corresponding to the data acquired by recording device 213, the data acquired by the camera can be intermediately stored in a storage device before the transmission. The camera can be operated by a further actuating device, corresponding to recording device 213.

FIG. 3 shows a block diagram of a management device 101 according to an exemplary embodiment of the present invention. Management device 101 can be used in connection with the system shown in FIG. 1. Management device 101 is fashioned so as to receive a transmitted signal that contains state data of a patient and to store it in a suitable form. In addition, management device 101 is fashioned so as to enable access to the stored data. For this purpose, management device 101 has a receive interface 321, a control device 323, a storage device 325, an input interface 327, and an output interface 329. Management device 101 can be realized as a computer or computer system.

Receive interface 321 is fashioned so as to receive a data file or data stream that is sent out for example by input device 103 described on the basis of FIG. 2. According to this exemplary embodiment, receive interface 321 is fashioned so as to receive wirelessly transmitted signals. For this purpose, receive interface 321 has a suitable antenna. According to this exemplary embodiment, receive interface 321 is fashioned so as to receive a text data file sent out by the input device. Receive interface 321 is fashioned so as to output the received text data file to control device 323. Control device 323 is fashioned so as to select, in storage device 222, a register that is assigned to the patient whose state data are contained in the received text data file. For this purpose, control device 323 can for example be fashioned so as to evaluate an identifier, contained in the text data file or appended to the text data file, of the input device that sent out the text data file. In addition, control device 323 is fashioned so as to write the text data file to the selected register of storage device and thus to store the text data file in storage device 325. If no text data file, but rather an audio data file or an audio signal, is received via receive interface 321, a converter can be connected between receive interface 321 and control device 323, said converter being fashioned so as to convert the audio data received by receive interface 321 into text data. For this purpose, the converter can be fashioned so as to carry out a speech recognition and to output a produced text data file to control device 323. If the data received by receive interface 321 are not already provided with a timestamp, receive interface 321 can be fashioned so as to provide the received data with a timestamp that defines the time of reception. Alternatively, control device 323 can be fashioned so as to provide the data with a timestamp defining the time of storage when they are stored in storage device 325.

Via input interface 327, the text data file stored in storage device 325, as well as additional text data files stored in storage device 325, relating to the one or several patients, can be accessed. Input interface 327 can be a user interface via which a user of management device 101 can input a request for access to the text data files stored in the storage device. According to this exemplary embodiment, input interface 327 is fashioned so as to output the request to control device 323. Control device 323 is fashioned so as to read out a text data file corresponding to the request, or a plurality of text data files corresponding to the request, from storage device 321 and to output them to output interface 329. Output interface 329 is fashioned to output the received data file or data files. For example, output interface 329 can be a display screen on which one data file, or a plurality of data files, can be displayed for the user. Alternatively, interfaces 327, 329 can be interfaces to a further device, for example a computer or a terminal.

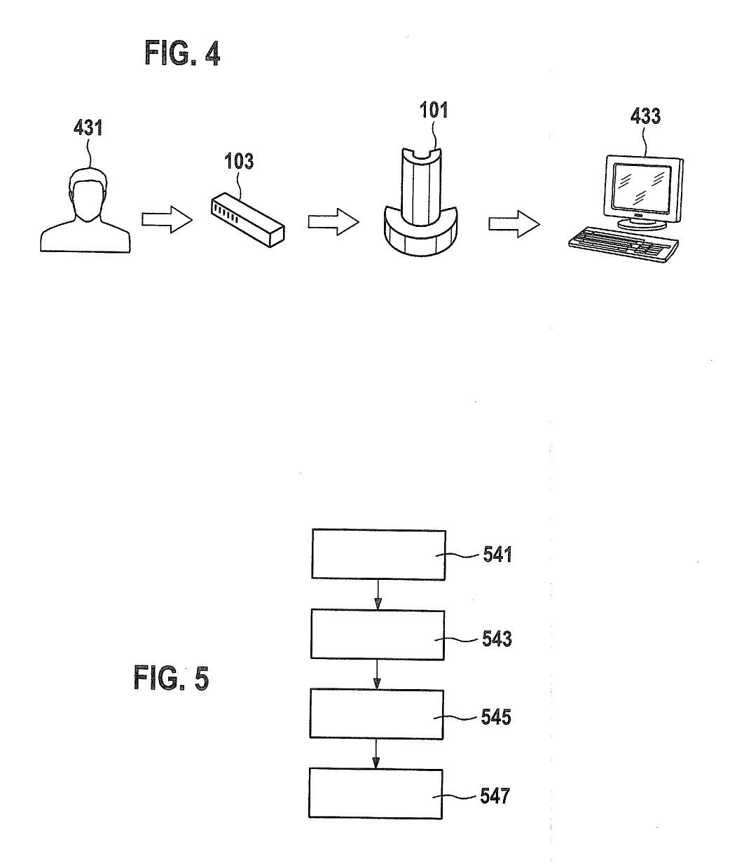

FIG. 4 shows a system for processing state data of a patient according to an exemplary embodiment of the present invention.

Shown is a patient 431, an input device 103 in the form of a recording device, a management device 101 in the form of a telemedical platform, and a user interface 433 in the form of a terminal by which a user can access information about patient 431 contained in the patient files of patient 431. User interface 433 can be part of the system, or can be coupled to the system. User interface 433 can be spatially separated, for example situated at a distance of some meters or kilometers, from management device 101. A plurality of user interfaces 433 can be connected to management device 101.

The patient files can be stored in management device 101 and can be continuously updated with recorded input from input device 103. Either input device 103 or management device 101 is fashioned so as to carry out speech recognition and a classification of the data acquired by input device 103.

In order to update the patient files of patient 431, patient 431 can use input device 103 to dictate a statement concerning his state into input device 103. The arrow shown between patient 431 and input device 103 indicates sound waves via which the statement of patient 431 is transmitted to input device 103 in the form of the acoustic signal. Input device 103 is fashioned so as to pick up the sound waves and convert them into an audio signal. In addition, input device 103 is fashioned so as to transmit the audio signal, or a text data file based on the audio signal, to management device 101 via a transmit interface indicated by an arrow between input device 103 and management device 101. Management device 101 is fashioned so as to add the text data file to a patient file assigned to patient 431. If input device 103 outputs the audio signal to management device 101, management device 101 is fashioned so as to convert the audio signal into the text data file. A further arrow between management device 101 and user interface 433 indicates that data from the patient file of patient 431 has been transmitted to user interface 433 and can be outputted by user interface 433. For this purpose, a preliminary request can be sent from user interface 433 to management device 101.

If patient 431 for example experiences heart pain, and thereupon takes a medication, the patient can use input device 103 to record the statement “experienced heart pain 5 minutes ago, took medication XY.” This statement is recorded by input device 103, for example at the time 12:30. Input device 103 is fashioned so as to perform speech recognition on the statement of patient 431 and to store it as a text data file. In addition, input device 103 is fashioned to add a timestamp to the text data file. A resulting set of data, which can additionally be supplemented with an identifier of patient 431 and subsequently stored in management device 101 and displayed via user interface 433, can have the following form:

Time: 12:30

Patient ID: xyz234

Message: “Experienced heart pain 5 minutes ago, took medication XY.”

According to an exemplary embodiment, the depicted system enables an acoustic recording, for example a speech input, of the subjective state of patient 431 as an entry in an electronic diary. The acoustic entries are converted into a text data file and are provided with a timestamp that can include date and clock time. These entries are transmitted to a database 101 in the form of a telemedical platform and are stored. The data sets can be supplemented with measurement data that can be transmitted to database 101 by various medical devices directly or via input device 103. For example, a medical device can be connected to database 101 via a wireless or wired interface, so that measurement data of patient 431 can also be recorded to the database. Input device 103 can also have an interface to a medical device so that measurement data of patient 431 can be transmitted by the medical device to input device 103 and can be transmitted by input device 103 to database 101. The transmission of the measurement data from the medical device to input device 103 can take place in a manner controlled by the medical device or controlled by patient 431. The input device can itself also have the functionality of a medical device, for example for measuring pulse, blood pressure, body temperature, or the like, so that measurement data of patient 431 can be acquired directly by the input device and communicated to database 101. The measurement data can be stored in database 101 as a separate data set assigned to patient 431 and provided with additional information, for example the clock time, or can be integrated into a data set that includes a text data file generated by a speech input of patient 431.

After transmission to a server 433, the entries can be examined and evaluated by expert medical personnel. In order to simplify the evaluation, algorithms such as semantic search functions or neural networks may be used. In this way, for example entries relevant to a diagnosis can quickly be found in database 101 and provided to the expert medical personnel.

The personal sensations stored in database 101 can provide important indications as to why, for example, vital parameters such as blood pressure, pulse, temperature, or blood sugar have worsened or improved.

According to an exemplary embodiment, the input device is realized as a recording device 103. Recording device 103 is activated using an operating button. After activation, 431 speaks a description of his current state into a microphone integrated in recording device 103. The recording, with precise date and clock time, is temporarily stored in recording device 103. The spoken sentences may contain placeholders, so-called tags, that can be replaced by values during speech recognition or later. Example: “My weight is TAG_WEIGHT.” The tags can be automatically recognized or marked as such by pressing a button on recording device 103.

Recording device 103 can be a device specially designed for this purpose or a mobile telephone or PDA (Personal Digital Assistant). If a conventional mobile device is used as recording device 103, the mobile device can be equipped with an additional software application fashioned to carry out the required steps for recording and transmitting the statement of patient 431.

After termination of the recording by recording device 103, the acoustic signal recorded by recording device 103 is converted into a text. The conversion of the speech inputs into a text data file can be carried out at various places in the system. For example, the conversion can take place in a recording device 103 developed specifically for this purpose, in a mobile telephone or PDA used for this purpose, in the telemedical base station or telemedical platform 101, or on server 433.

The transmission of the data in the form of raw data or a text data file from recording device 103 to telemedical platform 101, or to a server that realizes telemedical platform 101, can be carried out via a mobile telephone, mobile radio, Ethernet, or an existing telemedical system in which the transmission of the collected data takes place via a base station situated at the home of patient 431. If a separate recording device 103 is used, the transmission to the mobile telephone, which acts as a telemedical base station, or directly to the telemedical base station can take place using Bluetooth.

The evaluation of the data on server 101 can take place for example using keywords such as head pain, feelings of dizziness, or abdominal pain.

According to an exemplary embodiment, telemedical platform 101 includes a receive interface that can receive data via various paths, such as a modem or via the Internet. The received data are first stored in a database 101. All patient data can be analyzed by a server application, taking into account the patient's previous history, and stored. The audio speech recordings are pre-processed and stored. The original data can also be archived or deleted as necessary. The text data are added to the patient file so that the physician can view it in the context of other patient data.

According to an exemplary embodiment, input device 103 can be used to carry out a telephone call to management device 101 in the form of a data server. Speech of patient 431 transmitted during the telephone call is recognized and is added, as a free text comment, to the file of patient 431 in a database of management device 101. In this way, the system can form a platform for generating and storing short text messages that relate to the state of patient 431. Here, the text messages can automatically be generated from speech information of patient 431. The text messages form daily routine documentation assigned to patient 431. In this case, input device 103 is used for the acquisition and direct forwarding of the acquired speech data. Depending on the embodiment, the forwarded speech data can be supplemented by input device 103 with a timestamp and, additionally or alternatively, with a patient identifier. The further processing of the speech data can be carried out by management device 101.

Advantageously, patient 431 can always carry input device 103 with him in the form of a dictation device. If for example patient 431 speaks the sentence “Now experiencing headache” into dictation device 103, the data can be automatically recognized and transmitted to management device 101 as raw data or, with the aid of speech recognition, as text.

FIG. 5 shows a flow diagram of a method for processing state data of a patient according to an exemplary embodiment of the present invention. The method can be realized by the systems shown in FIGS. 1 and 4.

In a step 541, a time is acquired at which an acoustic signal of a patient is acquired. In a step 543, a data file representing the acoustic signal and provided with information about the time is transmitted. Steps 541, 543 can be realized by the input device shown in FIG. 2.

In a step 545, the data file is received and in a step 547 it is stored in the form of a text data file in a register or storage device assigned to the patient. Steps 545, 547 can be realized by the management device shown in FIG. 3.

The exemplary embodiments described and shown in the Figures are presented only as examples. Different exemplary embodiments may be combined with one another completely or with regard to individual features. An exemplary embodiment may also be supplemented with features of a further exemplary embodiment. In addition, method steps according to the present invention may be repeated, and may be executed in a sequence differing from that described.

What is claimed is:

1. A method for monitoring at least one patient, comprising:
a) acquiring a time of a reception of one of an acoustic or optical signal of the patient by an input device, the acoustic or optical signal representing a signal with which the patient can express his state;
b) transmitting a data file to a management device via a transmit interface of the input device, wherein the data file (i) represents the one of the acoustic or optical signal and (ii) is provided with an item of information concerning the time of reception;
c) receiving the data file at the management device via a receive interface of the management device; and
d) storing the data file in the form of one of a text data file or image data file in a register assigned to the patient and which includes a plurality of text data files or image data files.

2. The method as recited in claim 1, further comprising:
receiving at the management device a selection criterion via an input interface of the management device;
searching the plurality of text data files or image data files for a text data file or image data file corresponding to the selection criterion; and
outputting the text data file or image data file corresponding to the selection criterion via an output interface of the management device.

3. The method as recited in claim 1, wherein one of (i) the received data file representing the acoustic signal is converted into the text data file, or (ii) the received data file representing the optical signal is converted into the image data file.

4. The method as recited in claim 3, further comprising:
detecting an actuation of an actuation unit of the input device by the patient;
wherein the receiving and storing of the data file are initiated in response to the detecting of the actuation.

5. The method as recited in claim 4, wherein the data file is transmitted wirelessly to the management device.

6. The method as recited in claim 1, further comprising:
repeating steps a)-d) for a further patient using a further input device, wherein a further data file for the further patient is stored in a further register assigned to the further patient and which includes a plurality of text data files or image data files.

7. A method for monitoring a patient using an input device, comprising:
acquiring a time of a reception of one of an acoustic or optical signal of the patient by the input device, the acoustic or optical signal representing a signal with which the patient can express his state; and
providing a data file to a transmit interface of the input device, wherein the data file (i) represents the one of the acoustic or optical signal and (ii) is provided with an item of information concerning the time of reception.

8. A method for monitoring a patient using a management device, comprising:
receiving a data file via a receive interface of the management device, wherein the data file (i) represents one of an acoustic or optical signal of the patient transmitted from an input device and (ii) is provided with an item of information about a time of the acquisition of the acoustic or optical signal by the input device; and
storing the data file in the form of a text data file or image data file in a register assigned to the patient and which includes a plurality of text data files or image data files.

9. A system for monitoring at least one patient, comprising:
an input device; and
a management device;
wherein the input device includes: (a) an acquisition unit for acquiring a time of a reception of one of an acoustic or optical signal of the patient, the acoustic or optical signal representing a signal with which the patient can express his state; and (b) a transmit interface for transmitting a data file to a management device, wherein the data file (i) represents the one of the acoustic or optical signal and (ii) is provided with an item of information concerning the time of reception; and
wherein the management device includes: (c) a receive interface for receiving the data file; and (d) a storage including a register assigned to the patient for, storing the data file in the form of one of a text data file or image data file, the register including a plurality of text data files or image data files.

10. A non-transitory computer-readable data storage medium storing a computer program having program codes which, when executed on a computer, performs a method for monitoring at least one patient, the method comprising:
a) acquiring a time of a reception of one of an acoustic or optical signal of the patient by an input device, the acoustic or optical signal representing a signal with which the patient can express his state;
b) transmitting a data file to a management device via a transmit interface of the input device, wherein the data file (i) represents the one of the acoustic or optical signal and (ii) is provided with an item of information concerning the time of reception;
c) receiving the data file at the management device via a receive interface of the management device; and
d) storing the data file in the form of one of a text data file or image data file in a register assigned to the patient and which includes a plurality of text data files or image data files.
